(19) United States
(12) Patent Application Publication
(10) Pub. No.: US 2026/0121536 A1
(43) Pub. Date: Apr. 30, 2026

(54) SWITCHING REGULATOR CIRCUIT AND POWER SUPPLY CIRCUIT INCLUDING THE SAME

(71) Applicant: Samsung Electronics Co., Ltd., Suwon-si (KR)

(72) Inventors: Yuna JU, Suwon-si (KR); Hyungmin LEE, Seoul-si (KR); Hyunjun PARK, Seoul-si (KR); Junhyeok YANG, Suwon-si (KR); Sungmin YOO, Suwon-si (KR); Minsu KIM, Seoul-si (KR)

(73) Assignees: Samsung Electronics Co., Ltd., Suwon-si (KR); KOREA UNIVERSITY RESEARCH AND BUSINESS FOUNDATION, Seoul (KR)

(21) Appl. No.: 19/009,064

(22) Filed: Jan. 3, 2025

(30) Foreign Application Priority Data
May 8, 2024 (KR) 10-2024-0060840
Jul. 2, 2024 (KR) 10-2024-0087054

(51) Int. Cl. H02M 3/158; H02M 1/00; H02M 3/07

(52) U.S. Cl. CPC H02M 3/158; H02M 1/0095; H02M 3/07

(57) ABSTRACT

Example embodiments are directed to a switching regulator circuit that includes a converting stage including a first switch connected between an input node and a first node, a second switch connected between the first node and a second node, a third switch connected between the second node and a third node, a fourth switch connected between the third node and a fourth node, a first capacitor connected between the first node and the third node, and an inductor connected between the second node and an output node. The switching regulator circuit also includes an input stage including a second capacitor connected between the input node and a fifth node and a third capacitor connected between the fifth node and the fourth node, and a balancing control stage connected to the input stage and the converting stage and configured to control balancing of a voltage of the first capacitor.

### CROSS-REFERENCE TO RELATED APPLICATIONS

This U.S. non-provisional application claims priority under 35 U.S.C. § 119 to Korean Patent Application Nos. 10-2024-0060840, filed on May 8, 2024, and 10-2024-0087054, filed on Jul. 2, 2024, in the Korean Intellectual Property Office. The disclosures of both these applications are incorporated herein by reference in their entirety.

### BACKGROUND

Example embodiments of the inventive concepts relate to a switching regulator circuit based on a multi-level DC-DC converter, and to a power supply circuit including the same.

Voltage converters, such as a low drop-out (LDO) regulator, DC-DC buck converter, etc., may be used as step-down converters to convert high voltage at the input thereof to low voltage at the output thereof. In the case of LDO regulator, an input/output voltage difference may cause power loss, and reduce the operating efficiency of the LDO regulator. An inductor-based DC-DC buck converter using an LC low-pass filter may perform voltage conversion at a relatively higher efficiency. Multi-level DC-DC converters may reduce a voltage value at a node between an inductor and switches to half of an input voltage value by using flying capacitors. For a stable operation of multi-level DC-DC converters, it may be beneficial to balance the voltage of the flying capacitors.

### SUMMARY

Example embodiments of the inventive concepts provide a switching regulator circuit that may compensate for the voltage of a flying capacitor and provide a more stable output voltage over a wide conversion ratio range using mode conversion, and a power supply circuit including the switching regulator circuit.

According to some example embodiments of the inventive concepts, there is provided a switching regulator circuit that includes a converting stage including a first switch connected between an input node to which an input voltage is applied and a first node, a second switch connected between the first node and a second node, a third switch connected between the second node and a third node, a fourth switch connected between the third node and a fourth node, a first capacitor connected between the first node and the third node, and an inductor connected between the second node and an output node, an input stage including a second capacitor connected between the input node and a fifth node and a third capacitor connected between the fifth node and the fourth node, and a balancing control stage connected to the input stage and the converting stage and configured to control balancing of a voltage of the first capacitor.

According to some example embodiments of the inventive concepts, there is provided a switching regulator circuit including a multi-level converting stage including a flying capacitor and configured to step down an input voltage applied through an input node to generate an output voltage, a plurality of decoupling capacitors connected in series to the input node and configured to stabilize the input voltage, and a balancing control stage including a plurality of balancing switches connected to both terminals of the flying capacitor and the plurality of decoupling capacitors and configured to control voltage balancing of the flying capacitor by connecting the plurality of decoupling capacitors to the flying capacitor.

According to some example embodiments of the inventive concepts, there is provided a power supply circuit including a converting circuit configured to step down an input voltage through a switching operation of a plurality of switches to generate an output voltage and a switching control circuit configured to generate switching signals that control a switching operation of the plurality of switches based on a voltage level of the output voltage, wherein the converting circuit includes a 3-level buck converting stage including a plurality of converting switches to which the input voltage is applied, a flying capacitors, and an inductor, a plurality of decoupling capacitors connected in series to the input node and configured to stabilize the input voltage, and a balancing control stage including a plurality of balancing switches connected to both terminals of the flying capacitor and the plurality of decoupling capacitors and configured to control balancing of a voltage of the flying capacitor by connecting, when the plurality of converting switches perform a switching operation, the plurality of decoupling capacitor to the flying capacitor.

### BRIEF DESCRIPTION OF THE DRAWINGS

Example embodiments will be more clearly understood from the following detailed description taken in conjunction with the accompanying drawings.

FIG. 1 is a block diagram schematically illustrating an electronic device including a power supply circuit, according to some example embodiments.

FIG. 2 illustrates a switching regulator circuit, according to some example embodiments.

FIG. 3 illustrates a switching regulator circuit, according to some example embodiments.

FIGS. 4A, 4B, and 4C illustrate the operation of a switching regulator circuit, according to some example embodiments.

FIGS. 5A and 5B are timing diagrams of a switching regulator circuit, according to some example embodiments.

FIG. 6A illustrates an inductor voltage and an inductor current of a switching regulator circuit according to a comparative example, and FIG. 6B illustrates an inductor voltage and an inductor current of a switching regulator circuit, according to some example embodiments.

FIG. 7 illustrates a switching regulator circuit, according to some example embodiments.

FIGS. 8A and 8B illustrate modes of a switching regulator circuit, according to some example embodiments.

FIGS. 9A and 9B illustrate an operation of a switching regulator circuit in a second mode.

FIGS. 10A and 10B are timing diagrams of a switching regulator circuit according to a comparative example and a switching regulator circuit, according to some example embodiments, respectively.

FIG. 11 illustrates a switching regulator circuit, according to some example embodiments.

FIG. 12 illustrates a switching operation of an input stage and a balancing control stage in a first mode of a switching regulator circuit, according to some example embodiments.

FIGS. 13A, 13B, 13C, and 13D illustrate switching operations during four cycles of an input stage of a switching regulator circuit, according to some example embodiments.

FIG. 14 illustrates a switching control circuit, according to some example embodiments.

FIG. 15 is a block diagram illustrating an example of a configuration of an electronic device including a switching regulator circuit, according to some example embodiments.

### DETAILED DESCRIPTION

Hereinafter, some example embodiments are described in detail with reference to the accompanying drawings.

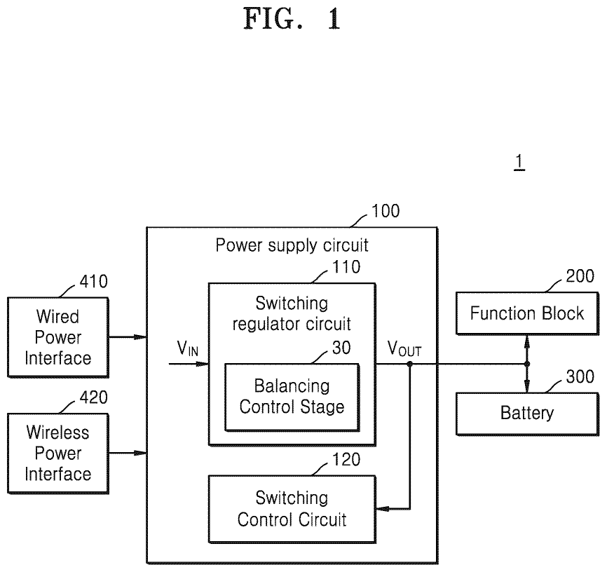

FIG. 1 is a block diagram schematically illustrating an electronic device 1 including a power supply circuit 100, according to some example embodiments.

Referring to FIG. 1, the electronic device 1 may include the power supply circuit 100, at least one functional block 200, and a battery 300. In some example embodiments, the electronic device 1 may include a wired power interface 410 and/or a wireless power interface 420. In addition, the electronic device 1 may further include a main processor and peripheral devices (e.g., I/O devices). For example, the electronic device 1 may include a mobile device, such as a smartphone, a tablet, a personal computer (PC), a mobile phone, a personal digital assistant (PDA), a laptop, a wearable device, a global positional system (GPS) device, an e-book reader, an Internet of Things (IoT) device, a digital camera, etc. For example, the electronic device 1 may include an electric vehicle.

The at least one functional block 200 may perform various functions performed within or by the electronic device 1 and may consume power. The battery 200 may be built into the electronic device 1 or may be removable from the electronic device 1.

The power supply circuit 100 may include a switching regulator circuit 110 and a switching control circuit 120, may convert an input voltage V_{IN} to generate an output voltage V_{OUT}, and may provide the output voltage V_{OUT} to the battery 200 and/or the at least one functional block 200. In some example embodiments, the power supply circuit 100 may be implemented as one or more integrated circuit chips and may be mounted on a printed circuit board.

In some example embodiments, the input voltage V_{IN} may be an external voltage that is received by the electronic device 1 via the wired power interface 410 and/or the wireless power interface 420. In some example embodiments, the wired power interface 410 may include a wired charging circuit, and the wireless power interface 420 may include a wireless charging circuit. For example, the wired charging circuit and the wireless charging circuit may include a rectifier, a regulator, and the like.

In some example embodiments, the power supply circuit 100 may further include a reference voltage generating circuit, and the input voltage V_{IN} may be generated by the reference voltage generating circuit based on an external power voltage or a power voltage provided from the battery 300. The reference voltage generating circuit may be implemented as a voltage dividing circuit using dividing resistors and/or may be implemented as a band-gap reference circuit that may provide a relatively stable reference voltage VREF that may have a reduced sensitivity to temperature changes.

The switching regulator circuit 110 may be or include a multi-level DC-DC converter based on an inductor. In some example embodiments, the switching regulator circuit 110 may be or include a 3-level DC-DC buck converter that may step down the input voltage V_{IN} to generate the output voltage V_{OUT}. Here, 3-level refers to the number of voltage levels used for switching operation. A 3-level DC-DC converter may generate the output voltage V_{OUT} by switching the input voltage V_{IN}, (½)×input voltage V_{IN}, and a ground voltage (e.g., 0 V).

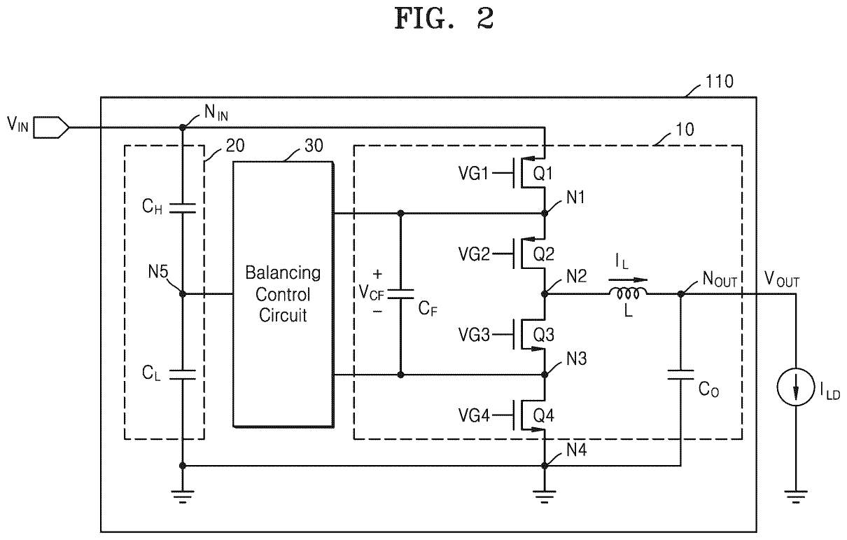

A multi-level DC-DC converter may include a plurality of switching elements (e.g., first to fourth switches Q1 to Q4 of FIG. 2), a flying capacitor (e.g., C_{F} of FIG. 2), and an inductor (e.g., L of FIG. 2). In order for the multi-level DC-DC converter to generate a stable output voltage (e.g., an output voltage having reduced or minimal voltage fluctuations and/or that maintains a steady voltage level), the voltage of the flying capacitor(s) may be needed to be balanced. For example, in a 3-level DC-DC converting circuit, the voltage of the flying capacitor may be maintained at a level that is half the input voltage V_{IN}, which may be referred to as balancing of a voltage Ver of the flying capacitor.

The switching regulator circuit 110 may include a balancing control stage 30 (or referred to as a balancing control circuit), and the balancing control stage 30 may control the voltage of the flying capacitor to maintain balancing. The balancing control stage 30 may control the voltage of the flying capacitor to maintain balancing by using a plurality of decoupling capacitors provided to stabilize the input voltage V_{IN}. Accordingly, the voltage of the flying capacitor may maintain balancing without a significant increase in area or a significant increase in unit price, and the switching regulator circuit 110 may stably (e.g., having reduced or minimal signal fluctuations) and efficiently generate the output voltage V_{OUT}.

In some example embodiments, the switching regulator circuit 110 may switch modes based on a conversion ratio of the output voltage V_{OUT} to the input voltage V_{IN} and may generate a stable output voltage V_{OUT} in a dead zone in which the conversion ratio may be close to 0.5.

The switching control circuit 120 may control a switching operation of the switching regulator circuit 110 so that the output voltage V_{OUT} of the switching regulator circuit 110 may be maintained at a target or desired level. The switching control circuit 120 may control the switching operation of the switching regulator circuit 110 based on the fed-back output voltage V_{OUT}. The switching control circuit 120 may provide a switching control signal to each of the switches provided in the switching regulator circuit 110. The switching control circuit 120 may generate a plurality of pulse width modulation (PWM) signals based on the duty and may generate a plurality of switching control signals based on the plurality of PWM signals.

In some example embodiments, the switching regulator circuit 110 may support at least one of various functions, such as an under-voltage lockout (UVLO) function, an over-current protection (OCP) function, an over-voltage protection (OVP) function, a soft-start function to reduce inrush current, a foldback current limit function, a hiccup mode function for short-circuit protection, and an over-temperature protection (OTP) function.

FIG. 2 illustrates the switching regulator circuit 110 of FIG. 1, according to some example embodiments.

Referring to FIG. 2, the switching regulator circuit 110 may include a converting stage 10, an input stage 20, and the balancing control stage 30.

The converting stage 10 may include a plurality of power switches, e.g., first to fourth switches Q1 to Q4, the flying capacitor Cr, an inductor L, and an output capacitor Co. The converting stage 10 may be implemented as a multi-level DC-DC converting circuit, and in some example embodiments, the converting stage 10 may be implemented as a 3-level DC-DC converting circuit.

The first to fourth switches Q1 to Q4 may be implemented as transistors. For example, the first and second switches Q1 and Q2 may be implemented as P-type metal oxide semiconductor (MOS) field effect transistor (hereinafter referred to as PMOS), and the third and fourth switches Q3 and Q4 may be implemented as N-type MOSFETs (hereinafter referred to as NMOS). However, example embodiments of the inventive concepts are not limited thereto, and the first to fourth switches Q1 to Q4 may all be implemented as PMOS or NMOS or the first to fourth switches Q1 to Q4 may be implemented as different types of switching elements.

The first to fourth switches Q1 to Q4 are connected in series. The first switch Q1 is connected between an input node Nix to which the input voltage V_{IN} is applied and a first node N1, the second switch Q2 is connected between the first node N1 and a second node N2, the third switch Q3 is connected between the second node N2 and a third node N3, and the fourth switch Q4 may be connected between the third node N3 and a fourth node N4. A ground voltage may be applied to the fourth node N4.

The first to fourth switches Q1 to Q4 may be turned on or off in response to first to fourth switching control signals VG1 to VG4, respectively. The first to fourth switching control signals VG1 to VG4 may be provided from the control circuit (120 in FIG. 1). The first and second switches Q1 and Q2 may be turned on in response to an ON level, e.g., a low level, of the first and second switching control signals VG1 and VG2 and turned off in response to an OFF level, e.g., a high level, of the first and second switching control signals VG1 and VG2. The third and fourth switches Q3 and Q4 may be turned on in response to an ON level, e.g., a high level, of the third and fourth switching control signals VG3 and VG4, and turned off in response to an OFF level, e.g., a low level, of the third and fourth switching control signals VG3 and VG4.

The flying capacitor C_{F} may be connected between the first node N1 and the third node N3, the inductor L may be connected between the second node N2 and an output node Nout, and the output capacitor Co may be connected to the output node Nout.

The converting stage 10 may step down the input voltage V_{IN} according to the switching operation of the first to fourth switches Q1 to Q4 to generate the output voltage V_{OUT}. The converting stage 10 may output the output voltage V_{OUT} through the output node Nout and provide a driving current ILD to a driving load, e.g., the one or more functional blocks (200 in FIG. 1) and/or the battery (300 in FIG. 1).

The input stage 20 may include a plurality of capacitors connected between the input node N_{IN} and the fourth node N4. In FIG. 2, two capacitors, e.g., a first capacitor C_{H} and a second capacitor C_{L}, are illustrated as being connected between the input node Nix and the fourth node N4, but this is merely an example, and in some example embodiments, more than 2 capacitors (e.g., four capacitors) may be connected between the input node Nix and the fourth node N4. A plurality of capacitors connected between the input node Nix and the fourth node N4 may stabilize the input voltage V_{IN} from external noise and interference and may be referred to as stabilizing capacitors or decoupling capacitors.

The balancing control stage 30 may compensate for the voltage Ver of the flying capacitor C_{F} (hereinafter referred to as the flying capacitor voltage V_{CF}) so that the flying capacitor voltage Ver may be maintained at half of the input voltage V_{IN}.

The balancing control stage 30 may connect the capacitors, e.g., the first capacitor C_{H} and the second capacitor C_{L}, of the input stage 20 to the flying capacitor C_{F}, thereby controlling the flying capacitor voltage V_{CF} to maintain balancing. The balancing control stage 30 may include a plurality of balancing switches, and the balancing switches may connect the first capacitor C_{H} or the second capacitor C_{L} to a first terminal and/or a second terminal of the flying capacitor C_{F} depending on a mode and a phase of the mode. The first capacitor C_{H} or the second capacitor C_{L} may share charges with the flying capacitor C_{H} so that the flying capacitor voltage V_{CF} may maintain balancing. In this manner, the first capacitor C_{H} and the second capacitor C_{L} may be used not only to stabilize the input voltage V_{IN} but also to balance the flying capacitor voltage V_{CF}.

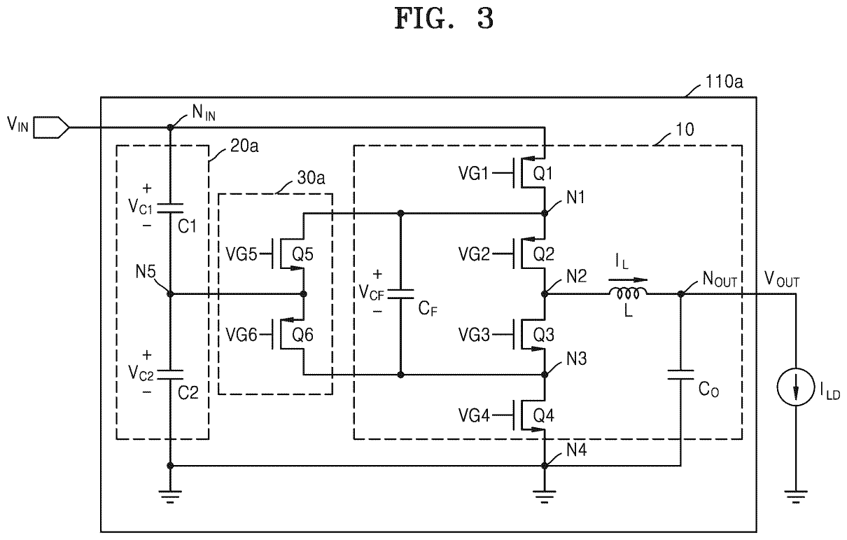

FIG. 3 illustrates a switching regulator circuit 110a according to some example embodiments. The switching regulator circuit 110a may be used as the switching regulator circuit 110 of FIG. 2.

Referring to FIG. 3, the switching regulator circuit 110a may include the converting stage 10, an input stage 20a, and a balancing control stage 30a.

The converting stage 10 may include first to fourth switches Q1 to Q4, the flying capacitor C_{H}, the inductor L, and the output capacitor Co and may be implemented as a 3-level converting circuit. Because the converting stage 10 is identical to the converting stage 10 of FIG. 2, a detailed description thereof is omitted herein for the sake of brevity.

The input stage 20a may include a first capacitor C1 and a second capacitor C2, and the first capacitor C1 and the second capacitor C2 may be connected in series between the input node N_{IN} and the fourth node N4 to stabilize the input voltage V_{IN}. A capacitance of the first capacitor C1 may be the same as or different from that of the second capacitor C2.

The balancing control stage 30a may include a fifth switch Q5 and a sixth switch Q6. The fifth switch Q5 may be connected to a fifth node N5 of the input stage 20a and a first node N1 of the converting stage 10. The sixth switch Q6 may be connected to the fifth node N5 of the input stage 20a and the third node N3 of the converting stage 10.

In some example embodiments, the fifth switch Q5 may be implemented as an NMOS and the sixth switch Q6 may be implemented as a PMOS. However, example embodiments of the inventive concepts are not limited thereto, and both the fifth switch Q5 and the sixth switch Q6 may be implemented with a PMOS or a NMOS, or the fifth switch Q5 and the sixth switch Q6 may be implemented as other types of switching elements.

The fifth switch Q5 may be turned on in response to an ON level, e.g., a high level, of a fifth switching control signal VG5, and turned off in response to an OFF level, e.g., a low level, of the fifth switching control signal VG5. The sixth switch Q6 may be turned on in response to an ON level, e.g., a low level, of a sixth switching control signal VG6, and turned off in response to an OFF level, e.g., a high level, of the sixth switching control signal VG6. The fifth switch Q5 and the sixth switch Q6 may be turned on complementarily so that the first capacitor C1 or the second capacitor C2 may be connected in parallel to the flying capacitor C_{F}. The fifth switching control signal VG5 and the sixth switching control signal VG6 may be provided from the switching control circuit (120 in FIG. 1).

The fifth switch Q5 and the sixth switch Q6 are switches that may be used for sharing charges between the first capacitor C1 or the second capacitor C2 and the flying capacitor C_{F}, and may not operate as power paths for providing the driving current ILD, and therefore may be smaller in size than the first to fourth switches Q1 to Q4, which may be used as power paths. For example, the sizes of the fifth switch Q5 and the sixth switch Q6 may be 0.1 times or less of the sizes of the first to fourth switches Q1 to Q4.

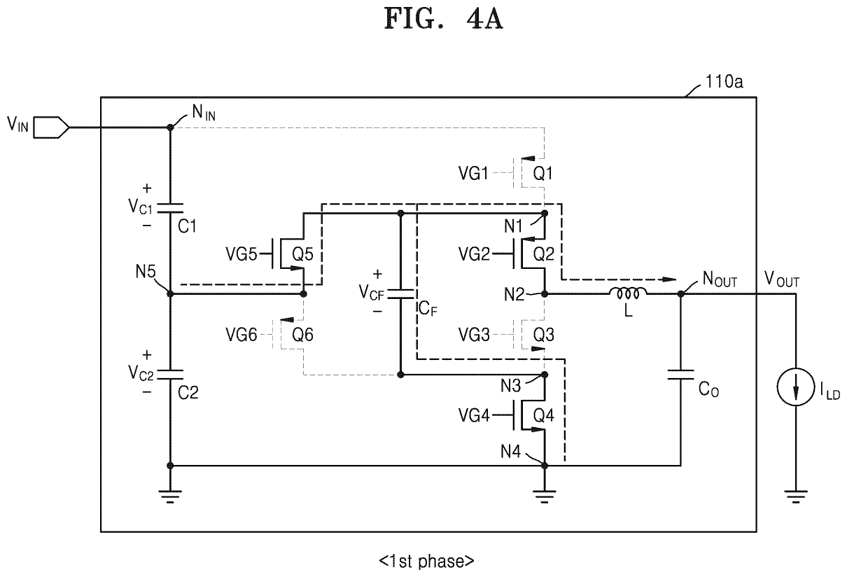

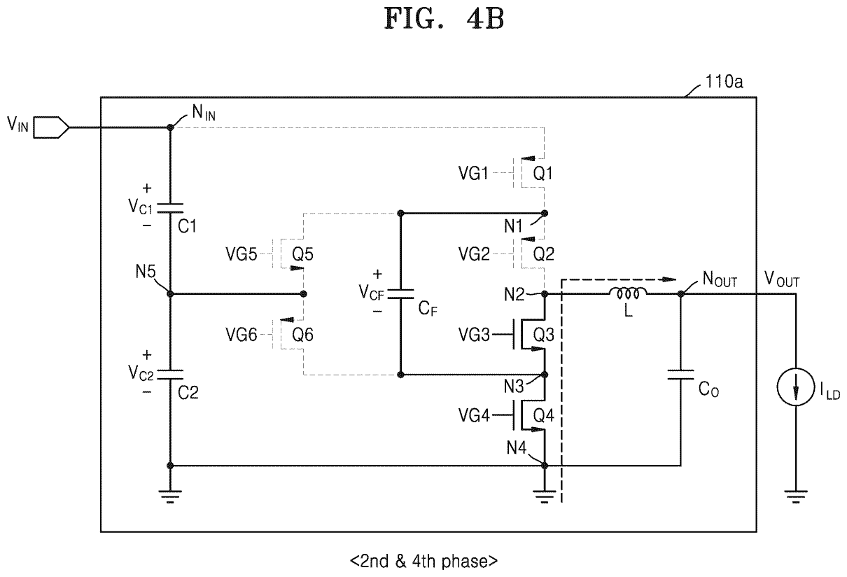

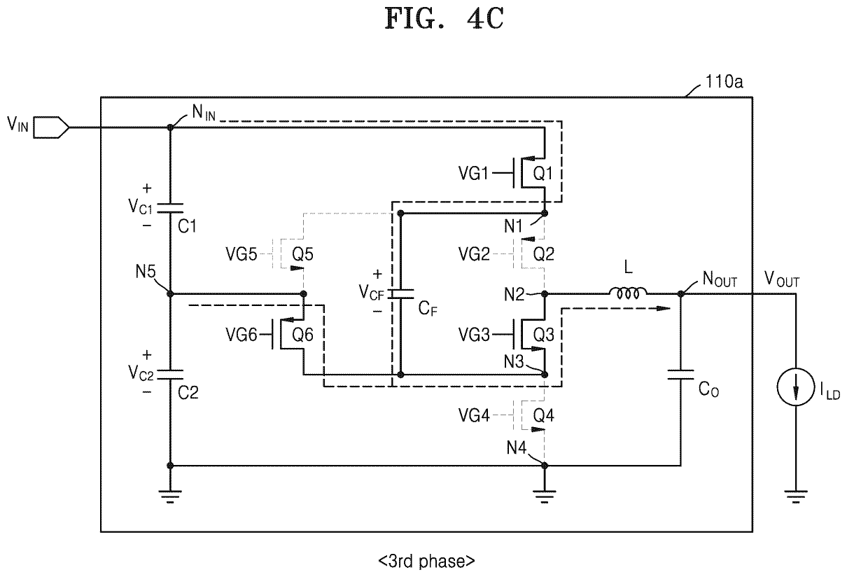

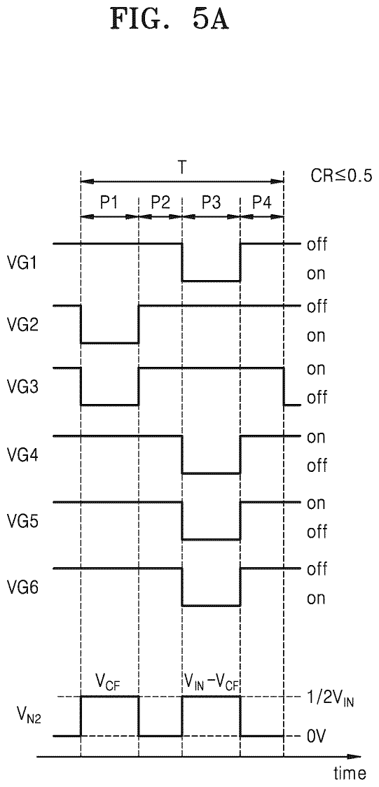

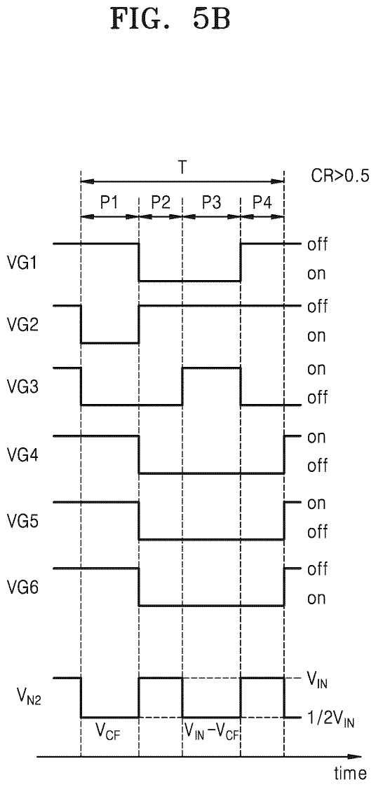

FIGS. 4A, 4B and 4C illustrate the operation of the switching regulator circuit 110a according to some example embodiments. FIGS. 5A and 5B are timing diagrams of the operation of the switching regulator circuit 110a, according to some example embodiments. FIG. 4A illustrates a first phase P1 of the operation of the switching regulator circuit 110a, FIG. 4B illustrates a second phase P2 and a fourth phase P4 of the operation of the switching regulator circuit 110a, and FIG. 4C illustrates a third phase P3 of the operation of the switching regulator circuit 110a.

Referring to FIGS. 4A and 5A together, the switching regulator circuit 110a may operate periodically and may operate in the first to fourth phases P1 to P4 during one period T.

In the first phase P1, the first and sixth switches Q1 and Q6 may be turned off in response to the first switching control signal VG1 and the sixth switching control signal VG6 of high level, respectively, and the third switch Q3 may be turned off in response to the third switching control signal VG3 having a low level. The second switch Q2 may be turned on in response to a second switching control signal VG2 having a low level, and the fourth switch Q4 and the fifth switch Q5 may be turned on in response to the fourth and fifth switching control signals VG4 and VG5 having a high level, respectively.

The second capacitor C2 may be connected in parallel to the flying capacitor C_{F}, and the second capacitor C2 and the flying capacitor C_{F} may share charges. The second capacitor voltage V_{C2} may be equal to the flying capacitor voltage V_{CF}. The flying capacitor voltage V_{CF} may be applied to the inductor L through the second node N2.

Referring to FIGS. 4B and 5A together, in the second phase P2 and the fourth phase P4, the first, second, and sixth switches Q1, Q2, and Q6 may be turned off in response to the first switching control signal VG1, the second switching control signal VG2, and the sixth switching control signal VG6 each having a high level, and the fifth switch Q5 may be turned off in response to the fifth switching control signal VG5 having a low level. The third switch Q3 and the fourth switch Q4 may be turned on in response to the third and fourth switching control signals VG3 and VG4 having a high level, respectively. A ground voltage may be applied to the inductor L through the second node N2.

Meanwhile, FIG. 5A shows a case in which a conversion ratio CR of the output voltage V_{OUT} to the input voltage V_{IN} is 0.5 or less, and as shown in FIG. 5B, when the conversion ratio of the output voltage V_{OUT} to the input voltage V_{IN} is greater than 0.5, the first switch Q1 and the second switch Q2 may be turned on in response to the first switching control signal VG1 and the second switching control signal each having a low level in the second phase P2 and the fourth phase P4, respectively. The input voltage V_{IN} may be applied to the inductor L through the second node N2.

Referring to FIG. 4C and FIG. 5A together, in the third phase P3, the first and sixth switches Q1 and Q6 may be turned on in response to the first switching control signal VG1 and the sixth switching control signal VG6 each having a low level, respectively, and the third switch Q3 may be turned on in response to the third switching control signal VG3 having a high level. In response to a high-level second switching control signal VG2, the second switch Q2 may be turned on, and in response to fourth and fifth switching control signals VG4 and VG5 each having a low level, the fourth switch Q4 and the fifth switch Q5 may be turned off, respectively.

The first capacitor C1 may be connected in parallel to the flying capacitor C_{F}, and the first capacitor C1 and the flying capacitor C_{F} may share charges. The first capacitor voltage V_{C1} may be equal to the flying capacitor voltage V_{CF}. A voltage (V_{IN}-V_{CF}) obtained by subtracting the flying capacitor voltage V_{CF} from the input voltage V_{IN} may be applied to the inductor L through the second node N2.

The switching regulator circuit 110a may maintain balancing of the flying capacitor voltage Ver in the first phase P1 and the second phase P2. Because the voltage at the fifth node N5 between the first capacitor C1 and the second capacitor C2 swings to the flying capacitor voltage V_{CF} and the voltage (V_{IN}−V_{CF}) obtained by subtracting the flying capacitor voltage V_{CF} from the input voltage V_{IN}, the flying capacitor voltage V_{CF} may be balanced (e.g., in a relatively short time) to a voltage (½×V_{IN}) that is 0.5 times the input voltage V_{IN}.

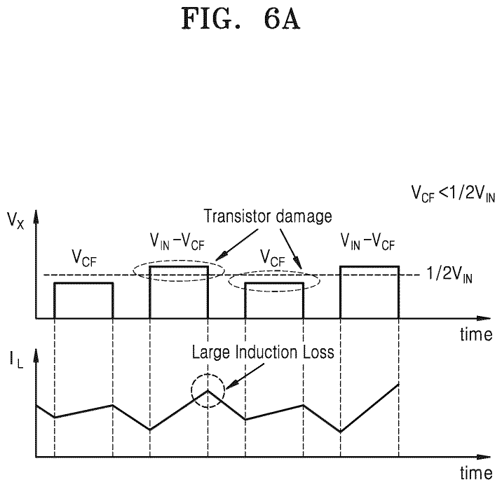

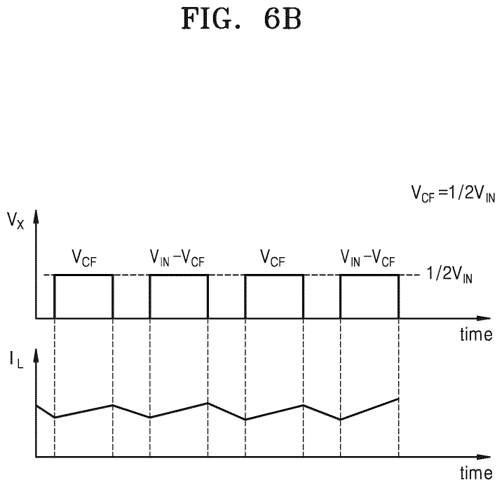

FIG. 6A illustrates an inductor voltage and an inductor current of a switching regulator circuit according to a comparative example, and FIG. 6B illustrates an inductor voltage and an inductor current of the switching regulator circuit 110a according to some example embodiments.

The operation of the converting stage 10 may be affected by parameter mismatch of a plurality of power switches, e.g., the first to fourth switches Q1 to Q4, timing delay of the first to fourth switching control signals VG1 to VG4, leakage current, and/or a parasitic capacitor. Parameter mismatch may cause fluctuations in the flying capacitor voltage V_{CF} during phase transition to maintain the flying capacitor voltage V_{CF} at a voltage (½×V_{IN}) corresponding to 0.5 times the input voltage V_{IN}.

If the switching regulator circuit according to the comparative example fails to maintain the balancing of the flying capacitor voltage V_{CF}, an inductor voltage Vx has different voltage levels in each phase, as shown in FIG. 6A, which causes ripple of the inductor current II, and an increase in consequent conduction loss. In addition, if a difference in voltages applied to each of the plurality of power switches, e.g., a voltage between terminals of a transistor implemented as a switch, exceeds an allowable voltage range due to an imbalance in the flying capacitor voltage Ver, the power switches may break down, which may lower the reliability of the switching regulator circuit.

The switching regulator circuit 110a, according to some example embodiments, may automatically maintain the balancing of the capacitor voltage Ver by the balancing control stage 30. Even if the flying capacitor voltage Ver is out of balance due to parameter mismatch, timing delay, leakage current, parasitic capacitor, etc., as the first phase P1 and the third phase P3 are repeated, the flying capacitor voltage Ver converges to a voltage (½×V_{IN}) corresponding to 0.5 times the input voltage V_{IN} through charge sharing between the first capacitor C1 or the second capacitor C2 and the flying capacitor C_{F}. Accordingly, as illustrated in FIG. 6B, the inductor voltage Vx (e.g., the voltage of the second node N2) may be maintained at a voltage (½×V_{IN}) that is 0.5 times the input voltage V_{IN}, and the ripple of the inductor current IL may be reduced or minimized.

If a separate loop circuit is added to the switching regulator circuit 110a to maintain the balance of the flying capacitor voltage V_{CF} or power switches and capacitors are added to add a power transmission path, the area of the switching regulator circuit 110a may increase and this may increase unit price.

However, the switching regulator circuit 110a, according to some example embodiments, may automatically maintain the balance of the flying capacitor voltage V_{CF} by using decoupling capacitors used to stabilize the input voltage V_{IN} without adding a separate loop circuit or power transmission path. Therefore, the balance of the flying capacitor voltage Ver may be maintained and an increase in the area of the switching regulator circuit 110a may be minimized and/or reduced and/or unit price of the switching regulator circuit 110a may be minimized and/or reduced.

Accordingly, the efficiency, operational stability and/or reliability of the switching regulator circuit 110a and the power supply circuit including the same may be improved or maximized, and an increase in circuit area and price may be reduced or minimized.

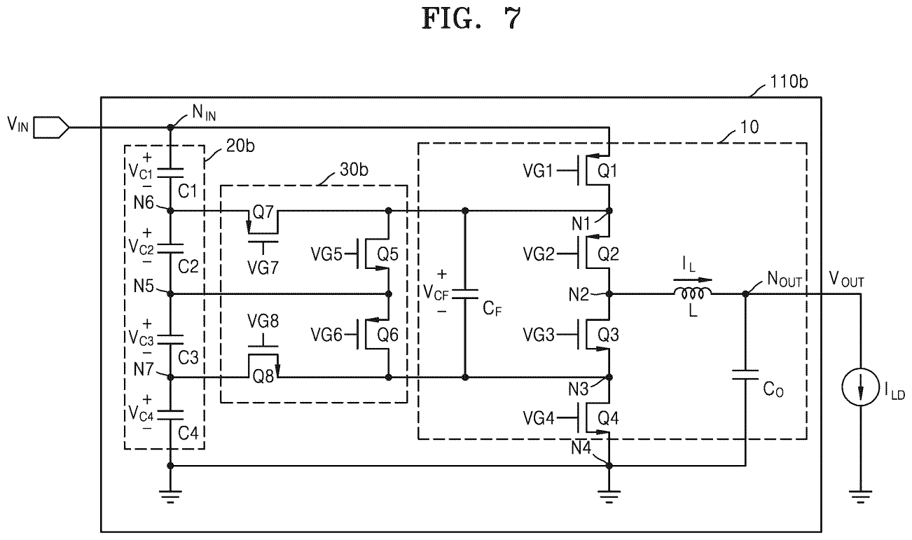

FIG. 7 illustrates a switching regulator circuit 110b according to some example embodiments. In some example embodiments, the switching regulator circuit 110b may be used as the switching regulator circuit 110 of FIG. 2 in the electronic device 1 of FIG. 1.

Referring to FIG. 7, the switching regulator circuit 110b may include the converting stage 10, an input stage 20b, and a balancing control stage 30b.

The converting stage 10 may include the first to fourth switches Q1 to Q4, the flying capacitor C_{H}, the inductor L, and the output capacitor Co and may be implemented as a 3-level converting circuit. Because the converting stage 10 is the same as the converting stage 10 of FIG. 2, a detailed description thereof is omitted herein for the sake of brevity.

The input stage 20b may include the first to fourth capacitors C1 to C4, and the first to fourth capacitors C1 to C4 may be connected in series between the input node N_{IN} and the fourth node N4, to stabilize the input voltage V_{IN}.

In some example embodiments, the capacitances of the first capacitor C1 to the fourth capacitor C4 may be the same. A first capacitor voltage V_{C1}, a second capacitor voltage V_{C2}, a third capacitor voltage V_{C3}, and a fourth capacitor voltage V_{C4} may be the same and may correspond to ¼ of the input voltage V_{IN}.

The balancing control stage 30b may include fifth to eighth switches Q5 to Q8. The fifth switch Q5 may be connected to the fifth node N5 of the input stage 20b and the first node N1 of the converting stage 10. The sixth switch Q6 may be connected to the fifth node N5 of the input stage 20b and the third node N3 of the converting stage 10. The seventh switch Q7 may be connected to the sixth node N6 of the input stage 20b and the first node N1 of the converting stage 10. The eighth switch Q8 may be connected to the seventh node N7 of the input stage 20b and the third node N3 of the converting stage 10.

In some example embodiments, the fifth switch Q5 and the eighth switch Q8 may be implemented as NMOS, and the sixth switch Q6 and the seventh switch Q7 may be implemented as PMOS. However, example embodiments of the inventive concepts are not limited thereto, and the fifth to eighth switches Q5 to Q8 may all be implemented as PMOS or NMOS or may be implemented as different types of switching elements.

The fifth switch Q5 and the eighth switch Q8 may be turned on in response to an ON level, e.g., a high level, of the fifth switching control signal VG5 and the eighth switching control signal VG8, respectively, and may be turned off in response to an OFF level, e.g., a low level, respectively. The sixth switch Q6 and the seventh switch Q7 may be turned on in response to an ON level, e.g., a low level, of the sixth switching control signal VG6 and the seventh switching control signal VG7, respectively, and may be turned off in response to an OFF level, e.g., a high level, of the sixth switching control signal VG6 and the seventh switching control signal VG7, respectively. The fifth to eighth switching control signals VG5 to VG8 may be provided from the switching control circuit (120 in FIG. 1).

The fifth to eighth switches Q5 to Q8 may be smaller in size than the first to fourth switches Q1 to Q4. For example, the size of the fifth to eighth switches Q5 to Q8 may be 0.1 times or less of the size of the first to fourth switches Q1 to Q4.

The switching regulator circuit 110b may operate in a first mode or a second mode. The switching regulator circuit 110b may operate in the first mode when the conversion ratio is less than or equal to a first reference value or greater than or equal to a second reference value and may operate in the second mode when the conversion ratio exceeds the first reference value and is less than the second reference value. The first reference value may be less than 0.5 and the second reference value may be greater than 0.5. In some example embodiments, the first reference value may be 0.4 and the second reference value may be 0.6.

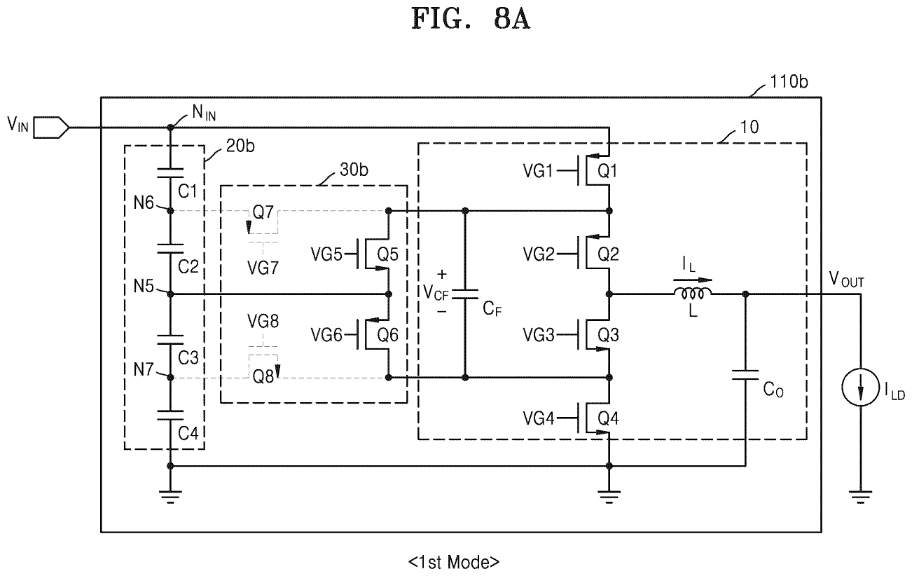

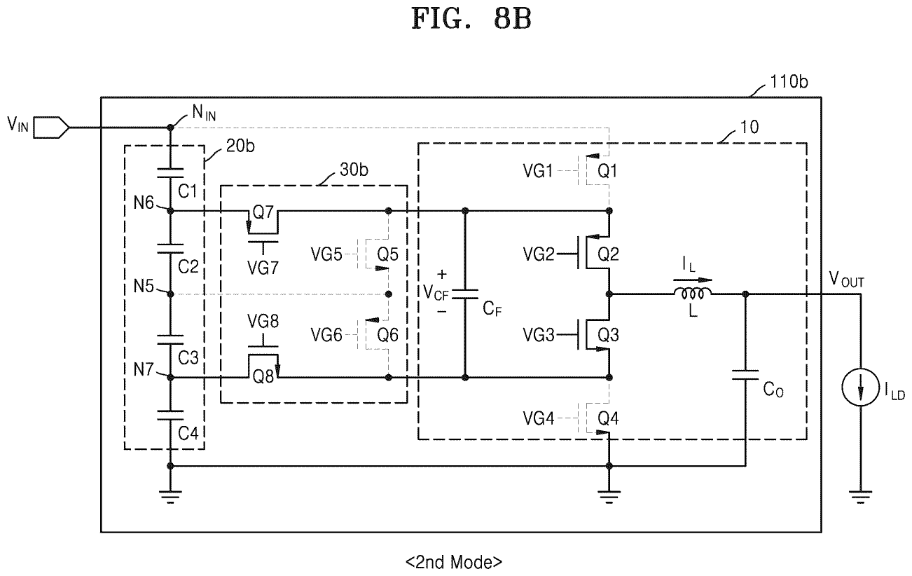

The operation of the switching regulator circuit 110b in the first mode and the second mode is described with reference to FIG. 8A and FIG. 8B.

FIGS. 8A and 8B illustrate modes of operation of the switching regulator circuit 110b according to some example embodiments. FIG. 8A illustrates the first mode of the switching regulator circuit 110b, and FIG. 8B illustrates the second mode of the switching regulator circuit 110b.

Referring to FIG. 8A, in the first mode, the seventh switch Q7 and the eighth switch Q8 may be turned off and the first to sixth switches Q1 to Q6 may perform a switching operation. In the first mode, the switching regulator circuit 110b may operate periodically and may operate in the first to fourth phases during one period. The operation of the switching regulator circuit 110b in the first to fourth phases is identical to the operation of the switching regulator circuit 110a in the first to fourth phases described above with reference to FIGS. 4A to 4C. The fifth switch Q5 and the sixth switch Q6 may be turned on complementarily to the first phase and the third phase, so that the first capacitor C1 or the second capacitor C2 may be connected in parallel with the flying capacitor C_{F}. Accordingly, the switching regulator circuit 110b may maintain balancing of the flying capacitor voltage V_{CF} in the first phase and the third phase.

Referring to FIG. 8B, in the second mode, the first switch Q1, the fourth switch Q4, the fifth switch Q5, and the sixth switch Q6 may be turned off, and the seventh switch Q7 and the eighth switch Q8 may be turned on. In addition, the second switch Q2 and the third switch Q3 may perform switching operations according to phases.

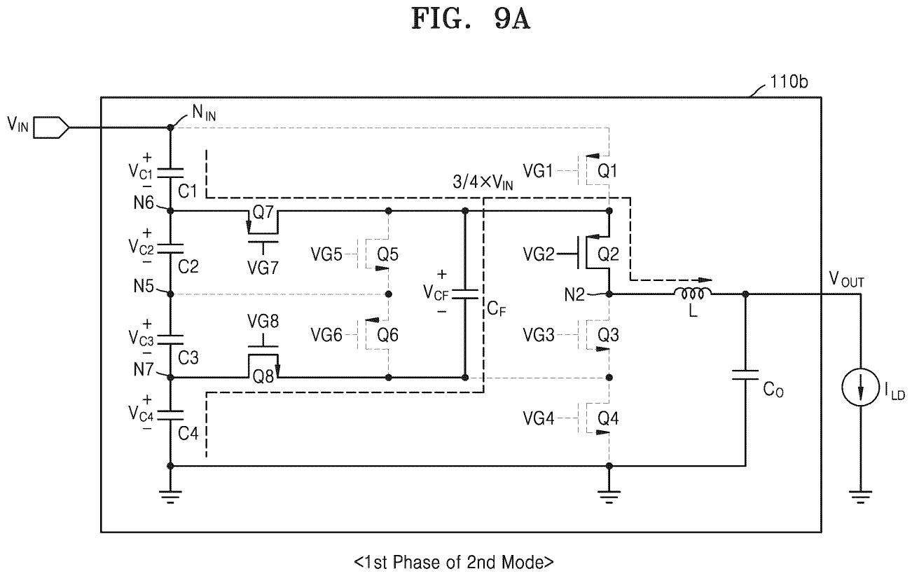

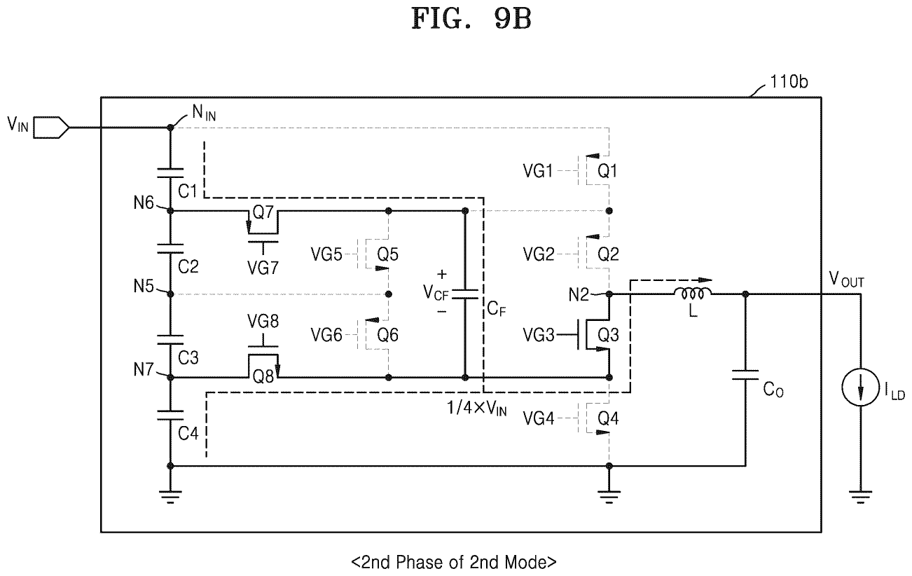

FIGS. 9A and 9B illustrate the operation of the switching regulator circuit 110b in the second mode. FIG. 9A illustrates the operation in the first phase, and FIG. 9B illustrates the operation in the second phase.

Referring to FIGS. 9A and 9B, the first capacitor voltage V_{C1}, the second capacitor voltage V_{C2}, the third capacitor voltage V_{C3}, and the fourth capacitor voltage VCa have a same capacitance and may correspond to ¼ of the input voltage V_{IN}. The seventh switch Q7 and the eighth switch Q8 may be turned on, so that the flying capacitor C_{F} may be connected to the sixth node N6 and the seventh node N7. Accordingly, the voltage of the first terminal of the flying capacitor C_{F} may be maintained at ¼ of the input voltage V_{IN}, the voltage of the second terminal may be maintained at ¾ of the input voltage V_{IN}, and balancing of the flying capacitor voltage V_{CF} may be maintained at ½ of the input voltage V_{IN}.

Referring to FIG. 9A, in the first phase, the second switch Q2 may be turned on and the third switch Q3 may be turned off. A voltage corresponding to ¾ of the input voltage V_{IN} (=¾V_{IN}) may be applied to the inductor L through the second node N2.

Referring to FIG. 9B, in the second phase, the second switch Q2 may be turned off and the third switch Q3 may be turned on. A voltage corresponding to ¼ of the input voltage V_{IN} (=¼V_{IN}) may be applied to the inductor L through the second node N2.

In this manner, in the second mode, the switching regulator circuit 110b may operate in the first phase and the second phase during one period, and the voltage applied to the inductor L, e.g., the voltage of the second node N2, may swing between the voltage corresponding to ⅓ (=¼×V_{IN}) of the input voltage V_{IN} and the voltage corresponding to ¼ (=¾ V_{IN}) of the input voltage V_{IN}.

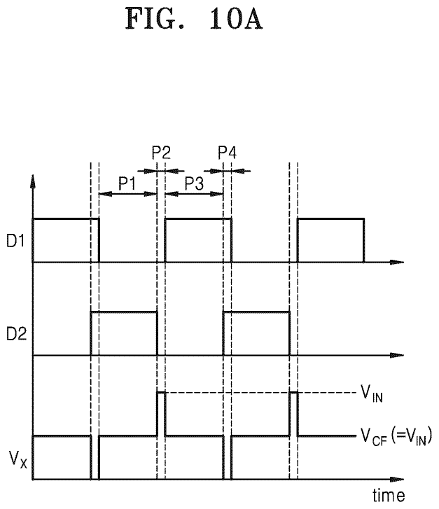

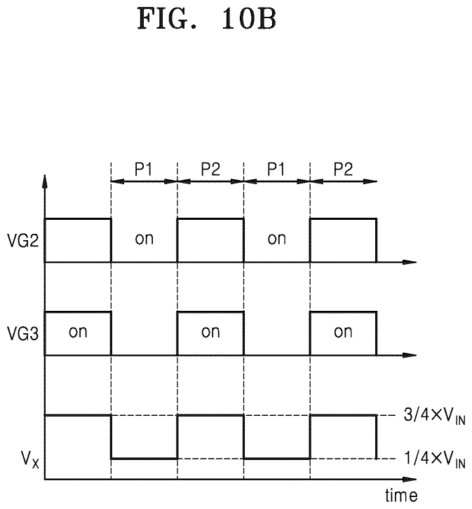

FIGS. 10A and 10B are timing diagrams of a switching regulator circuit according to a comparative example and a switching regulator circuit according to some example embodiments, respectively, when the conversion ratio is 0.5 (or about 0.5). FIG. 10A illustrates duty ratios D1 and D2 and an inductor voltage Vx of a switching regulator circuit according to a comparative example in which the operation of the second mode described above with reference to FIGS. 9A and 9B is not implemented, and FIG. 10B illustrates the second switching control signal, the third switching control signal, and the inductor voltage Vx (e.g., the voltage at the second node N2 of FIG. 7) when the switching regulator circuit 110b according to some example embodiments operates in the second mode.

Referring to FIG. 10A, a switching regulator circuit implemented as a 3-level DC-DC converter may require two duties, e.g., a first duty D1 and a second duty D2, to control power switches implemented as PMOS and NMOS. The second duty D2 is a signal that may be obtained by delaying the first duty D1 by 180 degrees. As described above with reference to FIGS. 5A and 5B, depending on the conversion ratio and the driving current, there may be a first case in which the inductor voltage Vx, e.g., the voltage of the second node V_{N2}, operates between 0 V (e.g., the level of the ground voltage) and ½ V_{IN} and a second case in which the inductor voltage Vx swings between ½×V_{IN} and V_{IN}.

If the conversion ratio is close to 0.5 (or about 0.5), for example, in a dead zone, a PWM signal controlled by a feedback loop may become erratic or undesirable. This may occur because an interval in which the first duty D1 and the second duty D2 overlap or do not overlap is relatively small, and the inductor voltage Vx may undesirably or uncontrollably switch between values in the first and second cases, as shown in FIG. 10A. Here, the inductor voltage Vx swings indiscriminately or erratically between 0 V_{IN}, ½× V_{IN}, and V_{IN}, which may cause relatively large ripples (or transients) in the inductor current and an output voltage. In addition, if ripples (or transients) in a low frequency band occur in an audible frequency band, acoustic noise may occur.

As described above, the switching regulator circuit 110b, according to some example embodiments, operates in the second mode when the conversion ratio is greater than 0.4 (or about 0.4) and less than 0.6 (or about 0.6), and, the switching regulator circuit 110b may operate in the second mode when the conversion ratio is 0.5 (or about 0.5).

Here, the second switching control signal Q2 and the third switching control signal Q3 may be generated based on the first duty D1 and/or the second duty D2. Depending on a phase, the second switch Q2 or the third switch Q3 may be turned on for a certain period of time, and the inductor voltage Vx may swing regularly between ⅓×V_{IN} and ¼×V_{IN}. Accordingly, the occurrence of relatively large ripples (or transients) in the inductor current II, and output voltage VOLT may be prevented, reduced, or minimized.

In addition, in the switching regulator circuit, according to the comparative example of FIG. 10A, because the inductor voltage Vx (the voltage of the first terminal of the inductor) swings from 0 V to V_{IN}, a swing range of the voltage between the two sides (e.g., Vx-V_{OUT}) of the inductor is −½ V_{IN} to ½ V_{IN}, whereas, in the switching regulator circuit 110a according to the embodiment of FIG. 10B, because the inductor voltage Vx swings from ¼ V to ¾ V_{IN}, the swing range of the voltage between the two sides (e.g., Vx−V_{OUT}) of the inductor is −¼ V_{IN} to ¼ V_{IN}. A swing width of the inductor voltage Vx in the switching regulator circuit 110a according to some example embodiments is relatively smaller than a swing width of the inductor voltage Vx in the regulator circuit according to the comparative example, and therefore, the amount of change in the inductor current II, may also be reduced, or minimized, and thus, power consumption may be reduced or minimized.

The switching regulator circuit 110b according to some example embodiments may balance (e.g., in a relatively shorter time period) the flying capacitor voltage V_{CF} and may generate a relatively stable output voltage V_{OUT} even when the conversion ratio is close to 0.5 (or about 0.5). In addition, the switching regulator circuit 110b according to some example embodiments may reduce or minimize power consumption.

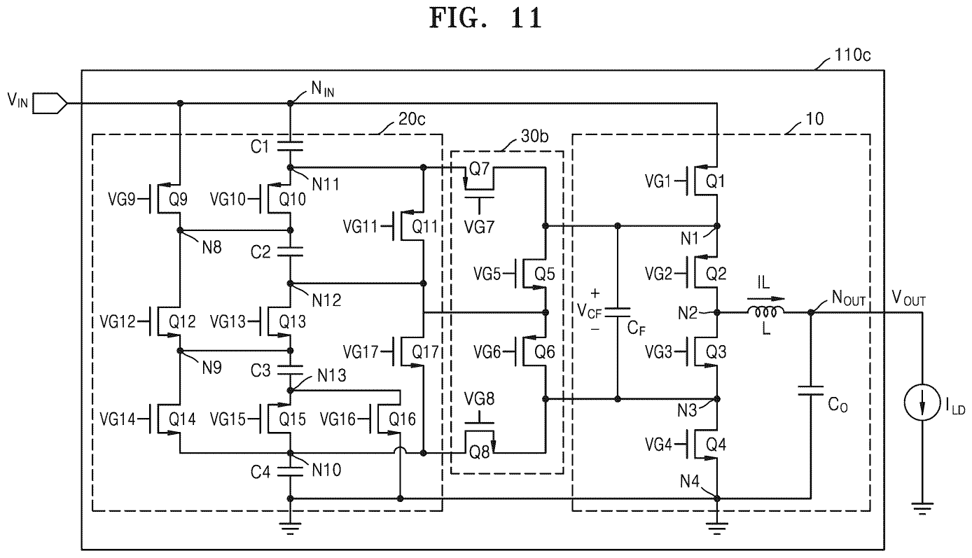

FIG. 11 illustrates a switching regulator circuit 110c, according to some example embodiments. The switching regulator circuit 110c of FIG. 11 may be similar in some respects to the switching regulator circuit 110b of FIG. 7, and therefore may be best understood with reference thereto where like numerals indicate like elements not described again in detail.

Referring to FIG. 11, the switching regulator circuit 110c may include the converting stage 10, an input stage 20c, and the balancing control stage 30b. The operations of the converting stage 10 and the balancing control stage 30b are the same as those described above with reference to FIGS. 8A to 9B, and a description thereof is omitted herein for the sake of brevity. The switching regulator circuit 110c may operate in the first mode or the second mode depending on the conversion ratio.

The input stage 20c may include first to fourth capacitors C1 to C4 and a plurality of switches, e.g., ninth to seventeenth switches Q9 to Q17. The ninth switch Q9 may be connected between the input node Nix to which the input voltage V_{IN} and an eighth node N8. The twelfth switch Q12 may be connected between the eighth node N8 and a ninth node N9. The fourteenth switch Q14 may be connected between the ninth node N9 and a tenth node N10. The ninth switch Q9, the twelfth switch Q12, and the fourteenth switch Q14 may be provided with a ninth switching control signal VG9, a twelfth switching control signal VG12, and a fourteenth switching control signal VG14, respectively. The first capacitor C1 may be connected between the input node Nix to which the input voltage V_{IN} is applied and an eleventh node N11. The tenth switch Q10 may be connected between the eleventh node N11 and the eighth node N8. The second capacitor C2 may be connected between the eighth node N8 and a twelfth node N12. The thirteenth switch Q13 may be connected between the twelfth node N12 and the ninth node N9. The third capacitor C3 may be connected between the ninth node N9 and a thirteenth node N13. The fifteenth switch Q15 may be connected between the thirteenth node N13 and the tenth node N10. The fourth capacitor C4 may be connected between the tenth node N10 and ground. The tenth switch Q10, the thirteenth switch Q13, and the fifteenth switch Q15 may be provided with a tenth switching control signal VG10, a thirteenth switching control signal VG13, and a fifteenth switching control signal VG15, respectively. The eleventeenth switch Q11 may be connected between the eleventeenth node N11 and the twelfth node N12. The seventeenth switch Q17 may be connected between the twelfth node N12 and the tenth node N10. The sixteenth switch Q16 may be connected between the thirteenth node N13 and the ground. The eleventeenth switch Q11, the seventeenth switch Q17, and the sixteenth switch Q16 may be provided with an eleventeenth switching control signal VG11, a seventeenth switching control signal VG17, and a sixteenth switching control signal VG16, respectively. The seventh switch Q7 may be connected between the eleventeenth node N11 and the first node N1. The fifth switch Q5 may be connected between the first node N1 and the twelfth node N12. The sixth switch Q6 may be connected between the twelfth node N12 and the third node N3. The eighth switch Q8 may be connected between the third node N3 and the tenth node N10. However, this is merely an example, and the number of the switches and capacitors and the interconnections therebetween may vary depending on application and/or design.

In some example embodiments, the ninth to eleventh switches Q9 to Q11 may be implemented as PMOS, and the twelfth to seventeenth switches Q12 to Q17 may be implemented as NMOS. However, in some other example embodiments, and the ninth to seventeenth switches Q9 to Q17 may all be implemented as PMOS or NMOS, or the ninth to seventeenth switches Q9 to Q17 may be implemented as other types of switching elements.

The ninth to seventeenth switches Q9 to Q17 may be turned on or off in response to ninth to seventeenth switching control signals VG9 to VG17, respectively. The ninth to seventeenth switches Q9 to Q17 may be switched according to a plurality of cycles to control a series connection and/or a parallel connection between the first to fourth capacitors C to C4. The input stage 20c may be referred to as a series-parallel-switched capacitor.

As described above with reference to FIG. 7, the first capacitor voltage to the fourth capacitor voltage V_{C1} to V_{C4} may correspond to ¼ of the input voltage V_{IN}. As the series connection and parallel connection between the first to fourth capacitors C1 to C4 change according to the cycle, the first capacitor voltage to the fourth capacitor voltage V_{C1} to V_{C4} may be stably maintained at the voltage corresponding to ¼ of the input voltage V_{IN}, and the voltage corresponding to ¼ (¼×V_{IN}) of the input voltage V_{IN} and the voltage (¾×V_{IN}) corresponding to ¾ of the input voltage V_{IN} may be provided to both terminals of the flying capacitor C_{F}.

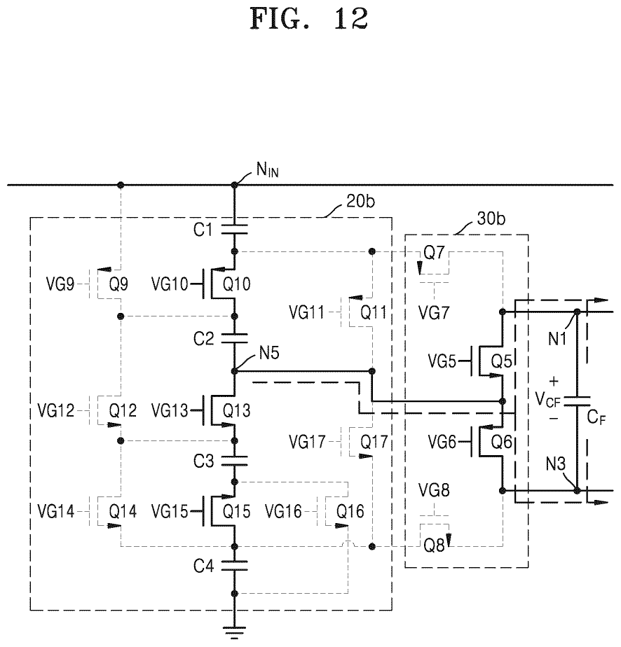

FIG. 12 illustrates a switching operation of the input stage 20c and the balancing control stage 30b in the first mode of the switching regulator circuit 110c, according to some example embodiments.

Referring to FIG. 12, in the first mode, the seventh switch Q7 and the eighth switch Q8 of the balancing control stage 30b are turned off. Among the ninth to seventeenth switches Q9 to Q17 of the input stage 20c, the tenth switch Q10, the thirteenth switch Q13, and the fifteenth switch Q15 may be turned on, so that the first to fourth capacitors C1 to C4 may be connected in series.

As described above with reference to FIG. 8A, the fifth switch Q5 and the sixth switch Q6 may be turned on complementarily in the first phase and the third phase to be connected in parallel to the first capacitor C1 and the second capacitor C2 to which the flying capacitor C_{F} is connected in series or to be connected in parallel to the third capacitor C3 and the fourth capacitor C4 to which the flying capacitor C_{F} is connected in series.

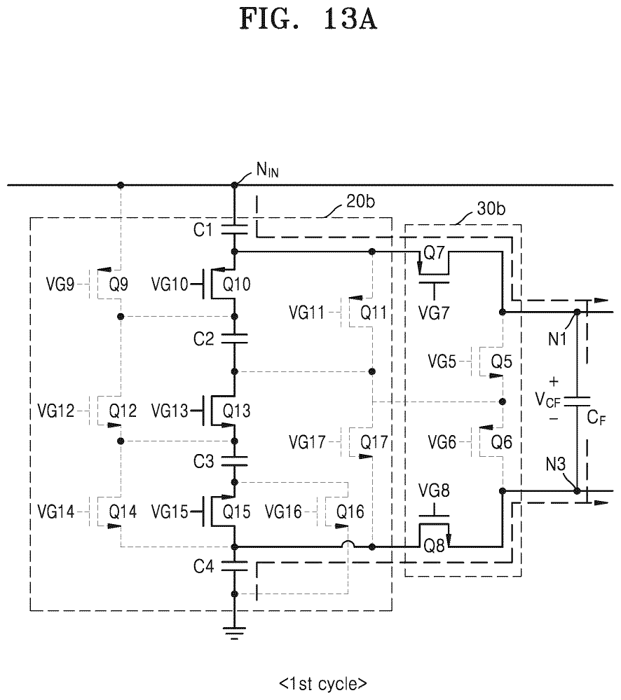

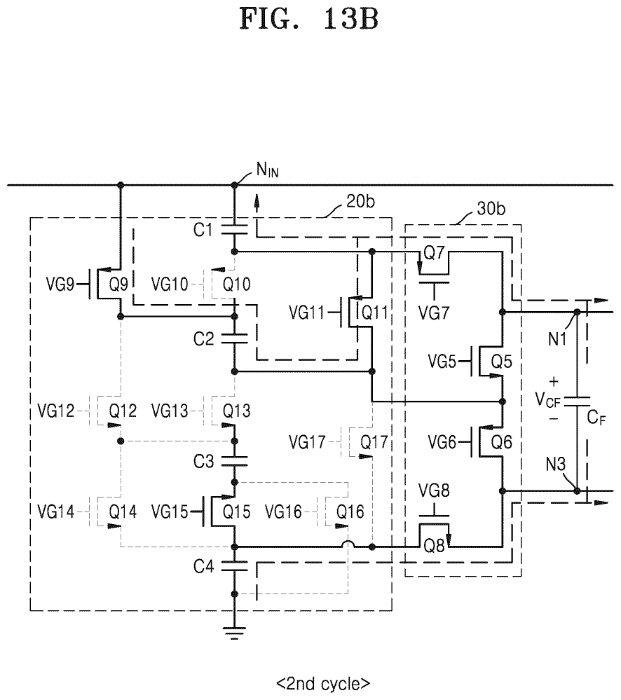

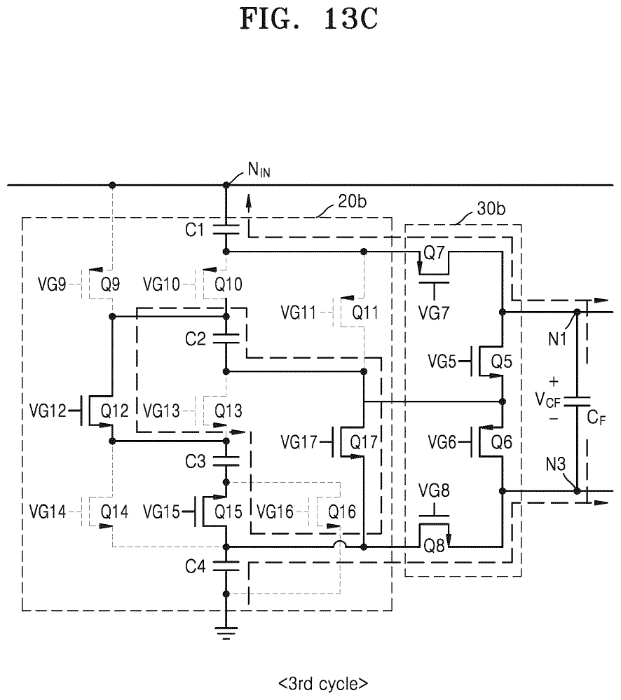

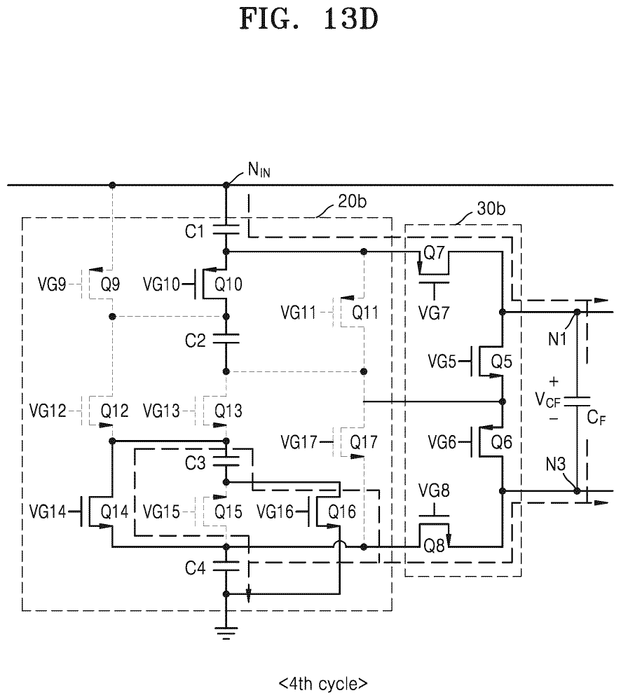

FIGS. 13A, 13B, 13C and 13D illustrate switching operations during four cycles of the input stage 20c in the second mode of the switching regulator circuit 110c, according to some example embodiments. When the switching regulator circuit 110c operates in the second mode, the input stage 20c may perform switching during four cycles, and in the second mode, the fifth switch Q5 and the sixth switch Q6 are turned off and the seventh switch Q7 and the eighth switch Q8 are turned on. In some example embodiments, the four cycles may be included in each of the first phase and the second phase (FIGS. 9A and 9B) of the second mode or may be synchronized with the periods of the first phase and the second phase. In some example embodiments, the four cycles may be independent of the first phase and the second phase of the second mode.

Referring to FIG. 13A, during a first cycle, among the ninth to seventeenth switches Q9 to Q17 of the input stage 20c, the tenth switch Q10, the thirteenth switch Q13, and the fifteenth switch Q15 may be turned on. Accordingly, the first to fourth capacitors C1 to C4 may be connected in series. The sum of the first capacitor voltage V_{C1}, the second capacitor voltage V_{C2}, the third capacitor voltage V_{C3}, and the fourth capacitor voltage V_{C4} may be equal to the input voltage V_{IN}. In some example embodiments, the first capacitor voltage V_{C1}, the second capacitor voltage V_{C2}, the third capacitor voltage V_{C3}, and the fourth capacitor voltage V_{C4} may be the same.

Referring to FIG. 13B, during a second cycle, among the ninth to seventeenth switches Q9 to Q17 of the input stage 20c, the ninth switch Q9, the eleventh switch Q11, and the fifteenth switch Q15 may be turned on. The first capacitor C1 and the second capacitor C2 may be connected in parallel. The first capacitor voltage V_{C1} may be equal to the second capacitor voltage V_{C2}.

Referring to FIG. 13C, during a third cycle, among the ninth to seventeenth switches Q9 to Q17 of the input stage 20c, the twelfth switch Q12, the fifteenth switch Q15, and the seventeenth switch Q17 may be turned on. The second switch C2 and the third switch C3 may be connected in parallel. The second capacitor voltage V_{C2} may be equal to the third capacitor voltage V_{C3}.

Referring to FIG. 13D, during a fourth cycle, among the ninth to seventeenth switches Q9 to Q17 of the input stage 20c, the tenth switch Q10, the fourteenth switch Q14, and the sixteenth switch Q16 may be turned on. The third capacitor C3 and the fourth capacitor C4 may be connected in parallel. The third capacitor voltage V_{C3} may be equal to the fourth capacitor voltage V_{C4}.

Because the first to fourth capacitors Q1 to Q4 share charges during the first to fourth cycles, the first capacitor voltage V_{C1}, the second capacitor voltage V_{C2}, the third capacitor voltage V_{C3}, and the fourth capacitor voltage V_{C4} may be maintained at a relatively steady voltage corresponding to ¼ of the input voltage V_{IN}.

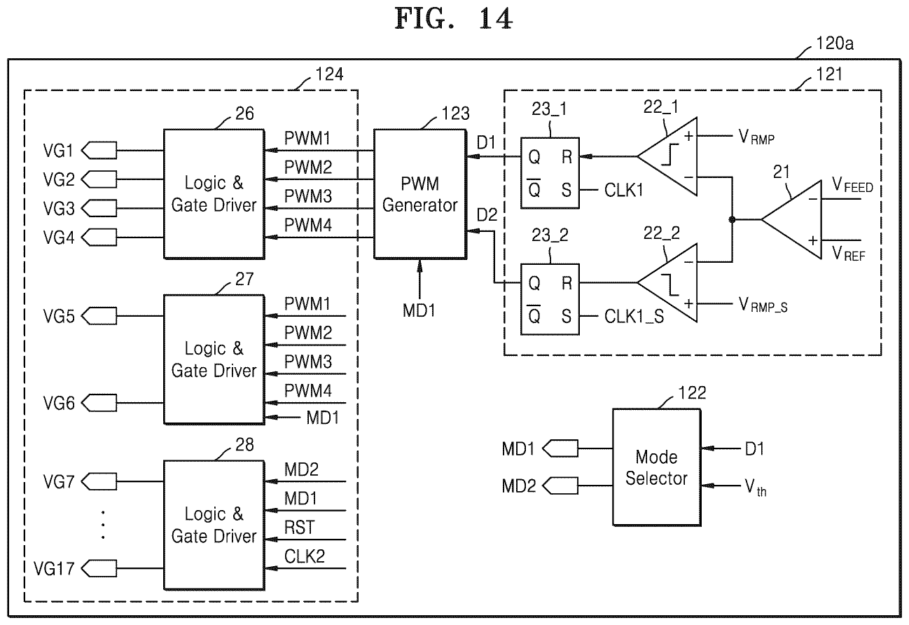

FIG. 14 illustrates a switching control circuit 120a according to some example embodiments. The switching control circuit 120a of FIG. 14 may generate first to seventeenth switching control signals VG1 to VG17 that control the switching operations of the switching regulator circuit 110c of FIG. 11.

Referring to FIG. 14, the switching control circuit 120a may include a duty generating circuit 121, a mode selector 122, a pulse width modulation (PWM) generator 123, and a switching control signal generating circuit 124. The duty generating circuit 121 may include an error detector 21, first and second comparators 22_1 and 22_2, and first and second SR latches 23_1 and 23_2. The switching control signal generating circuit 124 may include first to third logic and gate drivers 26, 27, and 28.

The error detector 21 may detect an error in the output voltage V_{OUT} based on a feedback voltage V_{FED} and a reference voltage VREF. Here, the error of the output voltage V_{OUT} may refer to a difference between a target level of the output voltage V_{OUT} and an actually generated voltage level. The feedback voltage V_{FED} may be generated based on the output voltage V_{OUT} and may be, for example, a voltage obtained by dividing the output voltage V_{OUT} based on a plurality of resistors. For example, when the feedback voltage V_{FED} is set to be half of the output voltage V_{OUT}, the voltage level of the reference voltage VREF may correspond to half of the target level of the output voltage V_{OUT}.

The first and second comparators 22_1 and 22_2 may compare the error signal detected by the error detector 21 with first and second ramp signals V_{RMP} and V_{RMP_s}. Here, the second ramp signal V_{RMP_s} may be a delayed signal of the first ramp signal V_{RMP} or a signal with the opposite phase. The first and second comparators 22_1 and 22_2 may compare the error signal with the first and second ramp signals V_{RMP} and V_{RMP_s} that increase or decrease at a predetermined slope and output comparison result signals, e.g., a first comparison result signal and a second comparison result signal, having levels that transition at a time when the first and second ramp signals V_{RMP} and V_{RMP_s} is higher than or lower than the error signal.

The first SR latch 23_1 may generate the first duty signal D1 based on the first comparison result signal output from the first comparator 22_1 and a first clock signal CLK1. The second SR latch 23_2 may generate the second duty signal D2 based on the second comparison result signal output from the first comparator 22_2 and a first delayed clock signal CLK1_S. The first delayed clock signal CLK1_S may be a delayed signal of the first clock signal CLK1 or a signal with the opposite phase. The second duty signal D2 may be a signal that is delayed by 180 degrees from the first duty signal D1.

The mode selector 122 may generate first and second mode signals MD1 and MD2 based on the first duty signal D1 and a threshold voltage Vth. The mode selector 122 may generate first and second mode signals MD1 and MD2 in a hysteretic comparison manner. When set to the first mode, the first mode signal MD1 may be at a high level and the second mode signal MD2 may be at a low level, and when set to the second mode, the first mode signal MD1 may be at a low level and the second mode signal MD2 may be at a high level.

For example, the mode selector 122 may generate a duty sensing voltage by averaging the first duty signal D1 at a predetermined period and compare the duty sensing voltage with the threshold voltage Vth to generate the first mode signal MD1 and the second mode signal MD2. For example, the threshold voltage Vth may include a first threshold voltage and a second threshold voltage with different voltage levels, and the mode selector 122 may compare each of a first threshold voltage and a second threshold voltage with the duty sensing voltage. The first threshold voltage may have a voltage level corresponding to the duty sensing voltage when a duty signal indicates 0.6, and the second threshold voltage may have a voltage level corresponding to the duty sensing voltage when the duty signal indicates 0.4. The mode selector 122 may generate the first and second mode signals MD1 and MD2 indicating the first mode when the first duty signal D1 is less than or equal to 0.4 or greater than or equal to 0.6 and may generate the first and second mode signals MD1 and MD2 indicating the second mode when the first duty signal D1 exceeds 0.4 and is less than 0.6. Accordingly, the switching regulator circuit (110a in FIG. 3 or 110b in FIG. 11) may operate in the second mode when the conversion ratio exceeds 0.4 (or about 0.4) and is less than 0.6 (or about 0.6) and may operate in the first mode when the conversion ratio is less than or equal to 0.4 (or about 0.4) or greater than or equal to 0.6 (or about 0.6).

The PWM generator 123 may generate first to fourth PWM signals PWMI to PWM4 based on the first and second duty signals D1 and D2 and the first mode signal MD1.

The first logic and gate driver 26 may generate first to fourth switching control signals VG1 to VG5 provided to the first to fourth switches Q1 to Q4, respectively, based on the first to fourth PWM signals PWMI to PWM4. The first logic and gate driver 26 may generate first to fourth logic signals corresponding to the first to fourth switches Q1 to Q4 based on the first to fourth PWM signals PWMI to PWM4 and convert (level shift) the voltage levels of the first to fourth logic signals into voltage levels for turning on and off the first to fourth switches Q1 to Q4, thereby generating the first to fourth switching control signals VG1 to VG5.

The second logic and gate driver 27 may generate fifth and sixth switching control signals VG5 and VG6 provided to the fifth and sixth switches Q5 and Q6, respectively, based on the first to fourth PWM signals PWMI to PWM4 and the first mode signal MD1.

The third logic and gate driver 28 may generate seventh to seventeenth switching control signals VG7 to VG17 provided to the seventh to seventeenth switches Q7 to Q17, respectively, based on the first and second mode signals MD1 and MD2, a reset signal RST, and a second clock signal CLK2. The second clock signal CLK2 may be used to generate the first to fourth cycles of FIGS. 13A to 13D, and the second clock signal CLK2 may be the same as or different from the first clock signal CLK1.

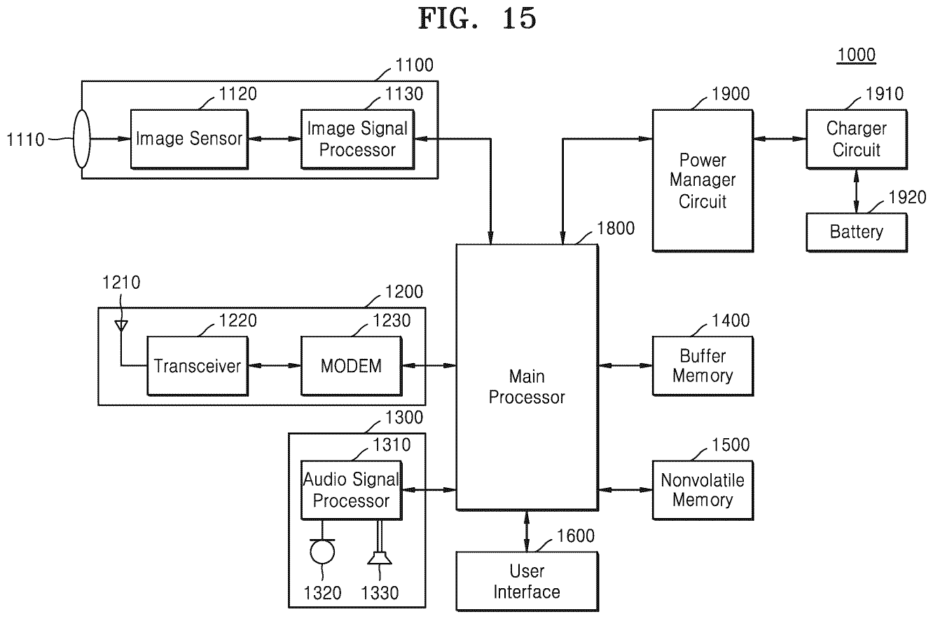

FIG. 15 is a block diagram illustrating an example of a configuration of an electronic device 1000 including a switching regulator circuit, according to some example embodiments.

The electronic device 1000 may include an image processing block 1100, a communication block 1200, an audio processing block 1300, a buffer memory 1400, a nonvolatile memory 1500, a user interface 1600, a main processor 1800, a power manager circuit (or power management circuit) 1900, and a charger circuit (or charger integrated circuit) 1910.

The electronic device 1000 may be connected to a battery 1920, and the battery 1920 may supply power used for the operation of the electronic device 1000. However, in some other example embodiments, the power supplied to the electronic device 1000 may be provided from an internal/external power source other than the battery 1920.

The image processing block 1100 may receive light through a lens 1110. An image sensor 1120 and an image signal processor 1130 included in the image processing block 1100 may generate image information related to an external object based on received light.

The communication block 1200 may exchange signals with an external device/system through an antenna 1210. A transceiver 1220 and a modulator/demodulator (MODEM) 1230 of the communication block 1200 may process signals exchanged with external devices/systems according to one or more of various wired/wireless communication protocols.

The audio processing block 1300 may process sound information using an audio signal processor 1310. The audio processing block 1300 may receive audio input through a microphone 1320 and output audio through a speaker 1330.

The buffer memory 1400 may store data used for the operation of the electronic device 1000. As an example, the buffer memory 1400 may temporarily store data processed or to be processed by the main processor 1800. For example, the buffer memory 1400 may include volatile memory, such as static random access memory (SRAM), dynamic RAM (DRAM), and synchronous DRAM (SDRAM), and/or nonvolatile memory, such as phase-change RAM (PRAM), magneto-resistive RAM (MRAM), resistive RAM (ReRAM), and ferro-electric RAM (FRAM).

The nonvolatile memory 1500 may retain data stored therein even in the absence of power supplied thereto. For example, the nonvolatile memory 1500 may include at least one of various nonvolatile memories, such as flash memory, PRAM (phase change RAM), MRAM (magnetic RAM), RRAM (resistive RAM), FeRAM (Ferroelectric RAM), etc. As an example, the nonvolatile memory 1500 may include removable memory, such as a secure digital (SD) card or a solid state drive (SSD), and/or embedded memory, such as an embedded multimedia card (cMMC).

The user interface 1600 may provide communication between a user and the electronic device 1000. As an example, the user interface 1600 may include an input interface for receiving input from a user and an output interface for providing information to the user.

The main processor 1800 may control the overall operations of the components of the electronic device 1000. The main processor 1800 may process various operations to operate the electronic device 1000. For example, the main processor 1800 may be implemented as a general-purpose processor, a special-purpose processor, an application processor, a microprocessor, etc. and may include one or more processor cores.

The power management circuit 1900 may supply power to the components of the electronic device 1000 and manage or control or otherwise regulate the power. For example, the power management circuit 1900 may output a system voltage based on power provided from the charger integrated circuit 1910 and/or the battery 1920. The power management circuit 1900 may control a frequency of each component, a voltage level of a provided system voltage, etc., depending on a temperature of the components, a mode (e.g., a performance mode, a standby mode, or a sleep mode), etc.

The charger integrated circuit 1910 may charge the battery 1920 based on power provided from an external or internal power source or provide power to the power management circuit 1900. Alternatively, the charger integrated circuit 1910 may provide power to an external device via a wired or wireless power interface based on power provided from the battery 1920.

The power supply circuit (100 of FIG. 1) described above with reference to FIGS. 1 to 14 may be applied to the electronic device 1000 as the charger integrated circuit 1910. The power supply circuit 100 may include a switching regulator circuit as a 3-level DC-DC converter. The switching regulator circuit may maintain balancing of a flying capacitor by using a plurality of decoupling capacitors used to stabilize an input voltage. In addition, the switching regulator circuit may operate more stably in a wide conversion ratio through mode conversion according to a conversion ratio.

As described herein, any devices, systems, modules, portions, units, controllers, circuits, and/or portions thereof according to any of the example embodiments, and/or any portions thereof (including, without limitation, one or more of the electronic device 1, power supply circuit 100 including the switching regulator circuit 110 and the switching control circuit 120, the balancing control stage 30, the converting stage 10, the input stage 20, the functional block 200, the wired power interface 410, the wireless power interface 420, the switching control circuit 120a including the duty generating circuit 121, the mode selector 122, the pulse width modulation (PWM) generator 123, and the switching control signal generating circuit 124, and elements thereof, the image processing block 1100, the communication block 1200, the audio processing block 1300, the buffer memory 1400, the nonvolatile memory 1500, the user interface 1600, the main processor 1800, the power manager circuit 1900, the charger circuit 1910, the image sensor 1120, the image signal processor 1130, the transceiver 1220, the modulator/demodulator (MODEM) 1230, the audio signal processor 1310, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A switching regulator circuit comprising:
a converting stage including a first switch connected between an input node to which an input voltage is applied and a first node, a second switch connected between the first node and a second node, a third switch connected between the second node and a third node, a fourth switch connected between the third node and a fourth node, a first capacitor connected between the first node and the third node, and an inductor connected between the second node and an output node;
an input stage including a second capacitor connected between the input node and a fifth node and a third capacitor connected between the fifth node and the fourth node; and
a balancing control stage connected to the input stage and the converting stage and configured to control balancing of a voltage of the first capacitor.

2. The switching regulator circuit of claim 1, wherein the balancing control stage includes:
a fifth switch connected between the fifth node and the first node; and
a sixth switch connected between the fifth node and the third node.

3. The switching regulator circuit of claim 2, wherein,
during a first phase, the second switch, the fourth switch and the fifth switch are configured to be turned on,
during a second phase, the third switch and the fourth switch are configured to be turned on or the first switch and the second switch are configured to be turned on,
during a third phase, the first switch, the third switch, and the sixth switch are configured to be turned on, and
during a fourth phase, the third switch and the fourth switch are configured to be turned on or the first switch and the second switch are configured to be turned on.

4. The switching regulator circuit of claim 3, wherein,
during the first phase, the third capacitor is connected in parallel to the first capacitor and configured to compensate for the voltage of the first capacitor, and
during the second phase, the second capacitor is connected in parallel to the first capacitor and configured to compensate for the voltage of the first capacitor.

5. The switching regulator circuit of claim 2, wherein
sizes of the fifth switch and the sixth switch are 0.1 times or less than sizes of the first switch, the second switch, the third switch, and the fourth switch.

6. The switching regulator circuit of claim 3, wherein
the input stage further includes a fourth capacitor and a fifth capacitor,
the second capacitor is connected to the input stage and a sixth node, the fourth capacitor is connected between the sixth node and the fifth node, the third capacitor is connected between the fifth node and a seventh node, and the fifth capacitor is connected between the seventh node and the fourth node, and
the balancing control stage includes:
a seventh switch connected between the first node and the sixth node; and
an eighth switch connected between the third node and the seventh node.

7. The switching regulator circuit of claim 6, wherein,
in a first mode, the seventh switch and the eighth switch are configured to be turned off, and
in a second mode, the first switch, the fourth switch, the fifth switch, and the sixth switch are configured to be turned off.

8. The switching regulator circuit of claim 7, wherein
the second mode is set in response to a conversion ratio of an output voltage to the input voltage being greater than a first reference value and less than a second reference value, and
the first mode is set in response to the conversion ratio being less than or equal to the first reference value or greater than or equal to the second reference value, wherein the first reference value is 0.4, and the second reference value is 0.6.

9. The switching regulator circuit of claim 7, wherein,
in the second mode,
during the first phase, the second switch, the seventh switch, and the eighth switch are configured to be turned on to provide a voltage corresponding to ¾ times the input voltage to the inductor through the second node, and
during the second phase, the third switch, the seventh switch, and the eighth switch are configured to be turned on to provide a voltage corresponding to ¼ times the input voltage to the inductor through the second node.

10. The switching regulator circuit of claim 9, wherein
the input stage further includes a plurality of switches that configured to control a series connection and a parallel connection between the second capacitor, the third capacitor, the fourth capacitor, and the fifth capacitor during a plurality of cycles in the second mode.

11. The switching regulator circuit of claim 10, wherein,
during a first cycle, the second capacitor, the third capacitor, the fourth capacitor, and the fifth capacitor are configured to be connected in series,
during a second cycle, the second capacitor and the third capacitor are configured to be connected in parallel to the input node and the fourth capacitor and the fifth capacitor are configured to be connected in series to the fourth node,
during a third cycle, the fourth capacitor and the fifth capacitor are configured to be connected in parallel to the seventh node, and
during a fourth cycle, the second capacitor and the fourth capacitor are configured to be connected in series to the input node and the fourth capacitor and the fifth capacitor are configured to be connected in parallel to the fourth node.

12. A switching regulator circuit comprising:
a multi-level converting stage including a flying capacitor and configured to step down an input voltage applied through an input node to generate an output voltage;
a plurality of decoupling capacitors connected in series to the input node and configured to stabilize the input voltage; and
a balancing control stage including a plurality of balancing switches connected to both terminals of the flying capacitor and the plurality of decoupling capacitors and configured to control voltage balancing of the flying capacitor by connecting the plurality of decoupling capacitors to the flying capacitor.

13. The switching regulator circuit of claim 12, wherein the multi-level converting stage further includes:
a second switch connected between a first node and a second node;
a third switch connected between the second node and a third node;
a fourth switch connected between the third node and a fourth node;
an inductor connected between the second node and an output node; and
a stabilizing capacitor connected to the output node, wherein
the flying capacitor is connected between the first node and the third node, and a ground voltage is applied to the fourth node.

14. The switching regulator circuit of claim 13, wherein the plurality of decoupling capacitors include:
a first decoupling capacitor connected between the input node and a sixth node;
a second decoupling capacitor connected between the sixth node and a fifth node;
a third decoupling capacitor connected between the fifth node and a seventh node; and
a fourth decoupling capacitor connected between the seventh node and the fourth node.

15. The switching regulator circuit of claim 14, wherein the balancing control stage is configured to connect the first decoupling capacitor and the second decoupling capacitor to a first terminal of the flying capacitor or connect the third decoupling capacitor and the fourth decoupling capacitor to a second terminal of the flying capacitor, in a first mode, and
the balancing control stage is configured to connect the first decoupling capacitor to the first terminal of the flying capacitor and connect the fourth decoupling capacitor to the second terminal of the flying capacitor, in a second mode.

16. The switching regulator circuit of claim 15, further comprising:
a plurality of switches connected to the fifth node, the sixth node and the seventh node configured to change a series connection and a parallel connection between the first to fourth decoupling capacitors in the second mode during a plurality of cycles.

17. The switching regulator circuit of claim 15, wherein,
the second mode is set in response to a conversion ratio of an output voltage to the input voltage being greater than a first reference value and less than a second reference value, and
the first mode is set in response to the conversion ratio being less than or equal to the first reference value or greater than or equal to the second reference value, and wherein the first reference value is 0.4, and the second reference value is 0.6.

18. A power supply circuit comprising:
a converting circuit configured to step down an input voltage through a switching operation of a plurality of switches to generate an output voltage; and
a switching control circuit configured to generate switching signals that control a switching operation of the plurality of switches based on a voltage level of the output voltage, wherein the converting circuit includes:
a 3-level buck converting stage including a plurality of converting switches to which the input voltage is applied, a flying capacitor, and an inductor;
a plurality of decoupling capacitors connected in series to an input node and configured to stabilize the input voltage; and
a balancing control stage including a plurality of balancing switches connected to both terminals of the flying capacitor and the plurality of decoupling capacitors and configured to control balancing of a voltage of the flying capacitor by connecting, in response to the plurality of converting switches performing a switching operation, the plurality of decoupling capacitor to the flying capacitor.

19. The power supply circuit of claim 18, wherein
the plurality of decoupling capacitors include a first decoupling capacitor, a second decoupling capacitor, a third decoupling capacitor, and a fourth decoupling capacitor connected in series to the input node, and
the balancing control stage is configured to:
connect the first decoupling capacitor and the second decoupling capacitor to a first terminal of the flying capacitor or connect the third decoupling capacitor and the fourth decoupling capacitor to a second terminal of the flying capacitor in a first mode, and
connect the first decoupling capacitor to the first terminal of the flying capacitor and connect the fourth decoupling capacitor to the second terminal of the flying capacitor in a second mode.

20. The power supply circuit of claim 19, wherein the switching control circuit is configured to:
detect a conversion ratio of an output voltage to the input voltage, and
set the second mode in response to the conversion ratio being is greater than a first reference value and less than a second reference value, and
set the first mode in response to the conversion ratio being less than or equal to the first reference value or greater than or equal to the second reference value.
